(19) United States
(12) Patent Application Publication
(10) Pub. No.: US 2014/0327831 A1
(43) Pub. Date: Nov. 6, 2014

(54) METHOD AND SYSTEM FOR DYNAMIC SCREENSHOT APPLIED TO MOBILE TERMINAL

(71) Applicant: TENCENT TECHNOLOGY (SHENZHEN) COMPANY LIMITED, SHENZHEN (CN)

(72) Inventors: Yulei LIU, Shenzhen (CN); Bo Hu, Shenzhen (CN); Huijiao Yang, Shenzhen (CN); Tingyong Tang, Shenzhen (CN); Ruiyi Zhou, Shenzhen (CN); Kai Zhang, Shenzhen (CN); Bosen He, Shenzhen (CN); Ying Huang, Shenzhen (CN); Wei Li, Shenzhen (CN); Cheng Feng, Shenzhen (CN); Xi Wang, Shenzhen (CN); Zhengkai Xie, Shenzhen (CN); Zhipei Wang, Shenzhen (CN); Renfang Liu, Shenzhen (CN)

(21) Appl. No.: 14/334,512

(22) Filed: Jul. 17, 2014

Related U.S. Application Data
(63) Continuation of application No. PCT/CN2014/072613, filed on Feb. 27, 2014.

(30) Foreign Application Priority Data
Mar. 6, 2013 (CN) 201310070699.4

(51) Int. Cl. H04N 5/265; G06F 3/03

(52) U.S. Cl. CPC H04N 5/265; G06F 3/03
USPC 348/659

(57) ABSTRACT

The present invention relates to computer technical field, and discloses a method and system for dynamic screenshot applied to mobile terminal, the mobile terminal includes a screen, the method includes: detecting an input dynamic screenshot starting command; responding to the dynamic screenshot starting command to continuous capture the contents displayed on the screen; detecting an input dynamic screenshot termination command; and responding to the dynamic screenshot termination command to terminate screenshot and stitch the continuous screenshot images together to form a dynamic video. The embodiments of the invention can capture and get a dynamic video and thereby expand the screenshot applications.

### CROSS REFERENCE TO RELATED APPLICATIONS

This application is a U.S. continuation application under U.S.C. §111(a) claiming priority under U.S.C. §§120 and 365(c) to International Application No. PCT/CN2014/072613, filed on Feb. 27, 2014, which claims the priority benefit of Chinese Patent Application No. 201310070699.4, entitled “METHOD AND SYSTEM FOR DYNAMIC SCREENSHOT APPLIED TO MOBILE TERMINAL” and filed on Mar. 6, 2013, the content of which is incorporated by reference herein in its entirety for all purposes.

### FIELD OF THE TECHNICAL

The present invention relates to computer technical field, and more particularly, to a method and a system for dynamic screenshot applied to a mobile terminal.

### BACKGROUND

With the increasingly rich of mobile phone functions, many mobile phones have a screenshot function. For example, in the mobile phone with the Android 4.0+ system or iOS system, users can capture screen by a combination of hardware buttons of the mobile phone, and save the captured screenshot to the mobile phone.

However, in practice, the existing mobile phone can only get static screenshots and save instant screenshot images of the mobile phone, which results in limitations to screenshot applications of the mobile phone.

### SUMMARY

Exemplary embodiments of the present invention provide a method for dynamic screenshot applied to mobile terminal, which can capture and obtain a dynamic video and thereof expand the screenshot applications.

According to a first aspect of the invention, it provides a method for dynamic screenshot applied to mobile terminal, the mobile terminal includes a screen, the dynamic screenshot method includes:

detecting an input dynamic screenshot starting command;

responding to the dynamic screenshot starting command to continuous capture the contents displayed on the screen;

detecting an input dynamic screenshot termination command; and

responding to the dynamic screenshot termination command to terminate screenshot and stitch the continuous screenshot images together to form a dynamic video.

Exemplary embodiments of the present invention provide a dynamic screenshot system applied to mobile terminal, which can capture and obtain a dynamic video and thereof expand the screenshot applications.

According to a second aspect of the invention, it provides a dynamic screenshot system applied to mobile terminal, the mobile terminal includes a screen, the dynamic screenshot system includes:

a first detecting unit, capable of detecting an input dynamic screenshot starting command and notifying a first response unit;

the first response unit, capable of responding to the dynamic screenshot starting command to continuously capture the contents displayed on the screen of the mobile terminal;

a second detecting unit, capable of detecting an input dynamic screenshot termination command and notifying the first response unit;

the first response unit, further capable of responding to the dynamic screenshot termination command to terminate screenshot and notify a stitching unit; and

the stitching unit, capable of stitching the continuous screenshot images from the first response unit together to form a dynamic video.

According to a third aspect of the invention, it provides a non-transitory computer readable storage medium, storing one or more programs for execution by one or more processors of a computer having a display, the one or more programs comprising instructions for:

detecting an input dynamic screenshot starting command;

responding to the dynamic screenshot starting command to continuous capture the contents displayed on the screen;

detecting an input dynamic screenshot termination command; and

responding to the dynamic screenshot termination command to terminate screenshot and stitch the continuous screenshot images together to form a dynamic video.

In the above exemplary embodiments of the present invention, when the mobile terminal detects the input dynamic screenshot starting command, the mobile terminal can respond the dynamic screenshot starting command, resulting in continuously capturing the contents displayed on the screen. When the dynamic screenshot termination command is detected, then the dynamic screenshot termination command is responded, and the mobile terminal terminates screenshot according to the dynamic screenshot termination command and stitches the continuous screenshot images together in turn to form the dynamic video. Therefore, in this way, the users can capture the dynamic video and can more easily and vividly obtain dynamic effect displayed on the screen of the mobile terminal, therefore expanding the applications of the screenshot technology.

### BRIEF DESCRIPTION OF THE DRAWINGS

The aforementioned features and advantages of the disclosure as well as additional features and advantages thereof will be more clearly understood hereinafter as a result of a detailed description of preferred embodiment when taken in conjunction with the drawings.

FIG. 1 is a flowchart of a method for dynamic screenshot applied to mobile terminal provided in one embodiment of the present invention;

FIG. 2 is a flowchart of a method for dynamic screenshot applied to mobile terminal provided in another embodiment of the present invention;

FIG. 3 is a block diagram of a dynamic screenshot system applied to mobile terminal provided in one embodiment of the present invention; and

FIG. 4 is a block diagram of a dynamic screenshot system applied to mobile terminals provided in yet another embodiment of the present invention.

### DETAILED DESCRIPTION OF ILLUSTRATED EMBODIMENTS

The present invention is hereinafter described further in detail with reference to the accompanying drawings so as to make the objective, technical solution, and merits of exemplary embodiments more apparent. The term “exemplary” used throughout this description means “serving as an instance, instance, or illustration,” and should not necessarily be construed as preferred or advantageous over other exemplary embodiments. It would be apparent that a person having ordinary skills in the art may obtain other embodiments based on the illustrated exemplary embodiments of the invention without paying any creative work, and these embodiments should also be within the protection scope sought by the present invention.

In various embodiments of the present invention, a method and system for dynamic screenshot applied to mobile terminal is provided and can capture and get a dynamic video, thereby expanding the screenshot applications. Are hereinafter described in detail.

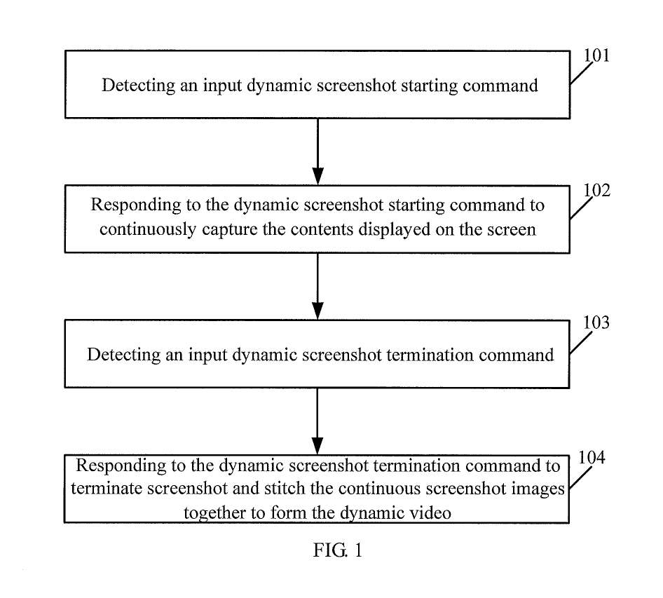

Referring to FIG. 1, FIG. 1 is a flowchart of a method for dynamic screenshot applied to mobile terminal provided in one embodiment of the present invention. The mobile terminal in the embodiment at least includes, but not limited to: smart phones, PDAs (Personal Digital Assistants), tablet computers and other MIDs (Mobile Internet Devices). As shown in FIG. 1, the dynamic screenshot applied to the mobile terminal in the embodiment of the present invention includes the following steps.

In step 101, detecting an input dynamic screenshot starting command.

In one embodiment of the invention, the mobile terminal can provide a combination of hardware buttons; therefore, a user can input a dynamic screenshot starting command when pressing the combination of the hardware buttons. In step 10, the mobile terminal can detect the input dynamic screenshot starting command. In practical applications, the dynamic screenshot starting command can by represented by a high-level signal or a low-level signal.

In step 102, responding to the dynamic screenshot starting command to continuously capture the contents displayed on the screen.

In the step 102, the mobile terminal can respond to the dynamic screenshot starting command and continuously capture the contents on the screen of the mobile terminal according to the dynamic screenshot starting command.

In the embodiment of the present invention, the contents on the screen of the mobile terminal can include, but not limited to: images or videos on the screen, or switching process between applications and the like.

Screenshot frequency is the number of occurrences of continuously capturing the contents displayed on the screen unit time, in the embodiment of the present invention, the screenshot frequency of dynamic screenshot is greater or equal to the frame rate (also known as frames per second) of the video displayed on the screen during normal operation of the mobile terminal. Thus, when the contents on the screen of the mobile terminal is a video, the continuous screenshot images are subsequently captured and are stitched together as dynamic video, which still cannot reduce the quality of the contents on the screen of the mobile terminal

The dynamic video composed of the screenshot images is formed by stitching screenshot images together according to the temporal sequence, thereof forming the dynamic video.

In step 103, detecting an input dynamic screenshot termination command.

In the step 103, the mobile terminal can detect an input dynamic screenshot termination command.

In one embodiment of the present invention, during the normal operation of the mobile terminal, when the user presses the combination of the hardware buttons provided on the mobile terminal for the first time, the dynamic screenshot starting command is input to the mobile terminal; when the user presses the combination of the hardware buttons, the dynamic screenshot termination command is input to the mobile terminal. Thus, the mobile terminal can detect the dynamic screenshot terminal command input by the user. In practical applications, the dynamic screenshot termination command can be represented in the form of high-level signal or low-level signal but in contrast to the dynamic screenshot starting command. For example, when the dynamic screenshot starting command is represented by the high-level signal, the dynamic screenshot terminal command can be represented by the low-level signal; when the dynamic screenshot starting command is represented by the low-level signal, the dynamic screenshot terminal command can be represented by the high-level signal.

In step 104, responding to the dynamic screenshot termination command to terminate screenshot and stitch the continuous screenshot images together to form the dynamic video.

In the step 104, the mobile terminal can respond to the dynamic screenshot termination command, and terminate the screenshot according to the dynamic screenshot termination command and stitch the continuous screenshot images together in turn to form the dynamic video.

In summary, the method for dynamic screenshot as shown in FIG. 1, the mobile terminal can detect the input dynamic screenshot starting command and respond the dynamic screenshot starting command, resulting in continuously capturing the contents displayed on the screen. When the dynamic screenshot termination command is detected, then the dynamic screenshot termination command is responded, and the mobile terminal terminates screenshot according to the dynamic screenshot termination command and stitches the continuous screenshot images together in turn to form the dynamic video. Therefore, in this way, the users can capture the dynamic video and can more easily and vividly obtain dynamic effect displayed on the screen of the mobile terminal, therefore expanding the applications of the screenshot technology.

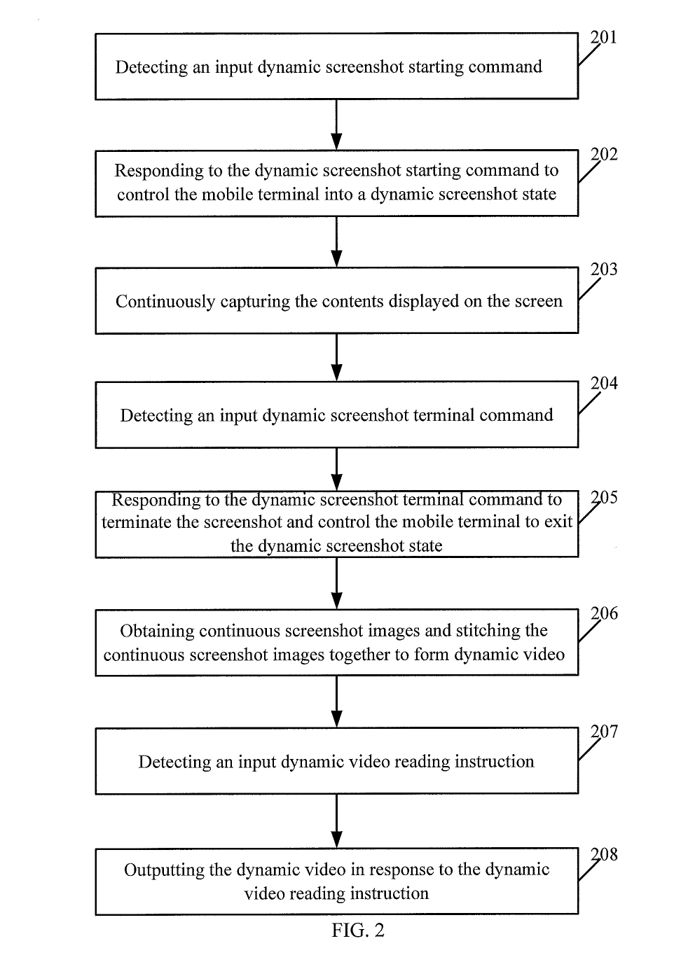

Referring to FIG. 2, FIG. 2 is a flowchart of a method for dynamic screenshot applied to mobile terminal provided in another embodiment of the present invention. As shown in FIG. 2, the dynamic screenshot applied to the mobile terminal in the embodiment of the present invention includes the following steps.

In step 201, detecting an input dynamic screenshot starting command

In step 202, responding to the dynamic screenshot starting command to control the mobile terminal into a dynamic screenshot state.

It should be understood that the mobile terminal can respond to the dynamic screenshot starting command and enter into a dynamic screenshot state, which can prevent other application processes from conflicting with the dynamic screenshot, resulting in the dynamic screenshot failed.

In step 203, continuously capturing the contents displayed on the screen.

In step 204, detecting an input dynamic screenshot terminal command.

In step 205, responding to the dynamic screenshot terminal command to terminate the screenshot and control the mobile terminal to exit the dynamic screenshot state.

In step 206, obtaining continuous screenshot images and stitching the continuous screenshot images together to form dynamic video.

In the embodiment of the invention, after the continuous screenshot images are stitched together into the dynamic video, the dynamic video is stored in the mobile terminal.

In step 207, detecting an input dynamic video reading instruction.

In step 208, outputting the dynamic video in response to the dynamic video reading instruction.

In this embodiment of the invention, by the method for dynamic screenshot as shown in FIG. 2, the mobile terminal can continuously capture the dynamic video and more easily and vividly obtain dynamic effect displayed on the screen of the mobile terminal, therefore expanding the applications of the screenshot technology.

In this embodiment of the invention, the method for dynamic screenshot applied to the mobile terminal as shown in FIGS. 1 and 2 can expand the applications of the screenshot technology, as well as provide technical solutions for dynamic screenshot and at the same time enrich the screenshot usage scenario of the mobile terminal.

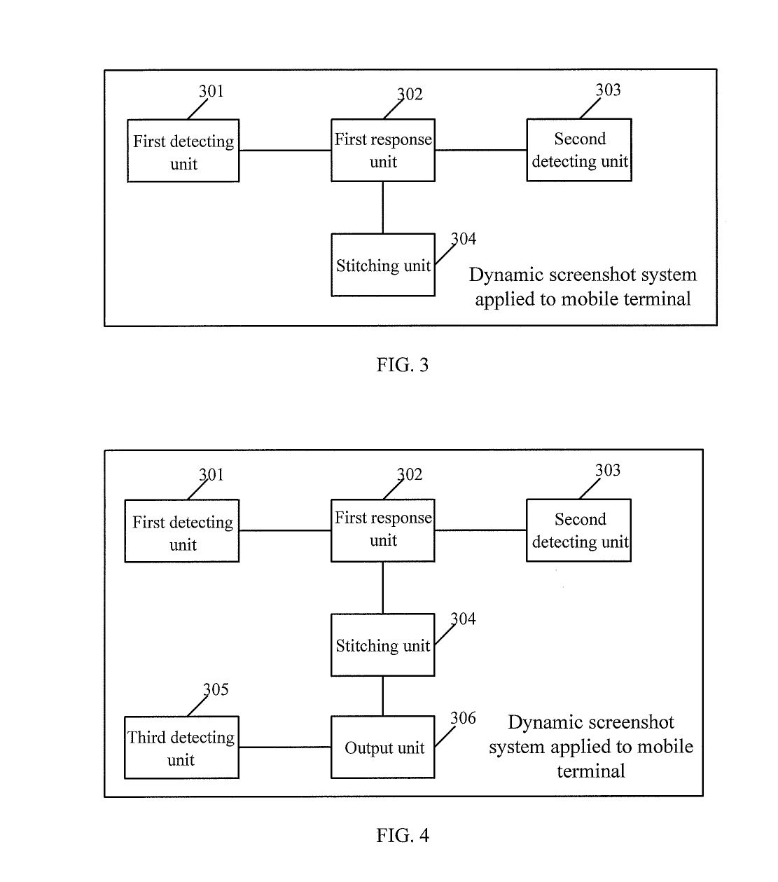

Referring to FIG. 3, FIG. 3 is a block diagram of a dynamic screenshot system applied to mobile terminal provided in one embodiment of the present invention. As shown in FIG. 3, the dynamic screenshot system in this embodiment may include: a first detecting unit 301, a first response unit 302, a second detecting unit 303 and a stitching unit 304.

The first detecting unit 301 is capable of detecting an input dynamic screenshot starting command and notifying the first response unit 302.

The first response unit 302 is capable of responding to the dynamic screenshot starting command to continuously capture the contents displayed on the screen of the mobile terminal.

The second detecting unit 303 is capable of detecting an input dynamic screenshot termination command and notifying the first response unit 302.

The first response unit 302 is further capable of responding to the dynamic screenshot termination command to terminate screenshot and notify the stitching unit 304.

The stitching unit 304 is capable of stitching the continuous screenshot images from the first response unit 302 together to form a dynamic video.

In one embodiment of the invention, the first response unit 302 is further capable of controlling the mobile terminal into a dynamic screenshot state between the response to the dynamic screenshot starting command and the continuous screenshot to the contents displayed on the screen of the mobile terminal. That is, after responding to the dynamic screenshot starting command and before the continuous screenshot to the contents displayed on the screen, the first response unit 302 is capable of controlling the mobile terminal into a dynamic screenshot state.

In yet another embodiment, the first response unit 302 is further capable of controlling the mobile terminal to exit the dynamic screenshot state after the termination screenshot.

Referring to FIG. 4, FIG. 4 is a block diagram of a dynamic screenshot system applied to mobile terminals provided in yet another embodiment of the present invention. The dynamic screenshot system applied to the mobile terminal in FIG. 4 is the optimization of the dynamic screenshot system as shown in FIG. 3, and the dynamic screenshot system applied to the mobile terminal as shown in FIG. 4 may further include: a third detecting unit 305 and an output unit 306.

The third detecting unit 305 is capable of detecting an input dynamic video reading instruction and notifying the output unit 306.

The output unit 306 is capable of outputting the dynamic video from the stitching unit 304 in response to the dynamic video reading instruction.

In this embodiment of the invention, the contents on the screen of the mobile terminal can include, but not limited to: images or videos on the screen, or switching process between applications and the like.

In the embodiment of the invention, the screenshot frequency of dynamic screenshot by the first response unit 302 is greater or equal to the frame rate (also known as frames per second) of the video displayed on the screen during normal operation of the mobile terminal. Thus, when the contents on the screen of the mobile terminal is the video, the stitching unit 304 can stitch the continuous screenshot images together to form the dynamic video, which still cannot reduce the quality of the contents on the screen of the mobile terminal.

In the embodiment of the invention, the dynamic screenshot applied to the mobile terminal as shown in FIGS. 3 and 4 can expand the applications of the screenshot technology, as well as provide technical solutions for dynamic screenshot and at the same time enrich the screenshot usage scenario of the mobile terminal.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of the present invention, but not intended to limit the protection scope of the present invention. Any variation or replacement made by persons of ordinary skills in the art without departing from the spirit of the present invention shall fall within the protection scope of the present invention. Therefore, the scope of the present invention shall be subject to be appended claims.

1. A method for dynamic screenshot applied to mobile terminal, the mobile terminal comprising a screen, the method comprising the steps of:
detecting an input dynamic screenshot starting command;
responding to the dynamic screenshot starting command to continuous capture the contents displayed on the screen;
detecting an input dynamic screenshot termination command; and
responding to the dynamic screenshot termination command to terminate screenshot and stitch the continuous screenshot images together to form a dynamic video.

2. The method of claim 1, after responding to the dynamic screenshot starting command and before the continuous screenshot to the contents displayed on the screen, the method further comprising the step of:
controlling the mobile terminal into a dynamic screenshot state.

3. The method of claim 2, after terminating the screenshot, the method further comprising the step of:
controlling the mobile terminal to exit the dynamic screenshot state.

4. The method of claim 1, wherein the method further comprises the steps of:
detecting an input dynamic video reading instruction; and
outputting the dynamic video in response to the dynamic video reading instruction.

5. The method of claim 1, wherein the contents on the screen of the mobile terminal comprise images or videos on the screen, or switching process between applications.

6. The method of claim 1, wherein the screenshot frequency of dynamic screenshot is greater or equal to the frame rate of the video displayed on the screen during normal operation of the mobile terminal.

7. A dynamic screenshot system applied to mobile terminal, the mobile terminal comprising a screen, wherein the dynamic screenshot system, comprising:
a first detecting unit, capable of detecting an input dynamic screenshot starting command and notifying a first response unit;
the first response unit, capable of responding to the dynamic screenshot starting command to continuously capture the contents displayed on the screen of the mobile terminal;
a second detecting unit, capable of detecting an input dynamic screenshot termination command and notifying the first response unit;
the first response unit, further capable of responding to the dynamic screenshot termination command to terminate screenshot and notify a stitching unit; and
the stitching unit, capable of stitching the continuous screenshot images from the first response unit together to form a dynamic video.

8. The dynamic screenshot system of claim 7, wherein the first response unit is further capable of controlling the mobile terminal into a dynamic screenshot state after responding to the dynamic screenshot starting command and before the continuous screenshot to the contents displayed on the screen.

9. The dynamic screenshot system of claim 8, wherein the first response unit is capable of controlling the mobile terminal to exit the dynamic screenshot state after terminating the screenshot.

10. The dynamic screenshot system of claim 7, further comprising a third detecting unit and an output unit, wherein,
the third unit is capable of detecting an input dynamic video reading instruction; and
the outputting unit is capable of outputting the dynamic video in response to the dynamic video reading instruction.

11. The dynamic screenshot system of claim 7, wherein the contents on the screen of the mobile terminal comprise images or videos on the screen, or switching process between applications.

12. The dynamic screenshot system of claim 7, wherein the screenshot frequency of dynamic screenshot is greater or equal to the frame rate of the video displayed on the screen during normal operation of the mobile terminal.

13. (canceled)

14. The method of claim 4, wherein the contents on the screen of the mobile terminal comprise images or videos on the screen, or switching process between applications.

15. The method of claim 2, wherein the screenshot frequency of dynamic screenshot is greater or equal to the frame rate of the video displayed on the screen during normal operation of the mobile terminal.

16. The method of claim 3, wherein the screenshot frequency of dynamic screenshot is greater or equal to the frame rate of the video displayed on the screen during normal operation of the mobile terminal.

17. The method of claim 4, wherein the screenshot frequency of dynamic screenshot is greater or equal to the frame rate of the video displayed on the screen during normal operation of the mobile terminal.

18. The dynamic screenshot system of claim 10, wherein the contents on the screen of the mobile terminal comprise images or videos on the screen, or switching process between applications.

19. The dynamic screenshot system of claim 8, wherein the screenshot frequency of dynamic screenshot is greater or equal to the frame rate of the video displayed on the screen during normal operation of the mobile terminal.

20. The dynamic screenshot system of claim 9, wherein the screenshot frequency of dynamic screenshot is greater or equal to the frame rate of the video displayed on the screen during normal operation of the mobile terminal.

21. The dynamic screenshot system of claim 10, wherein the screenshot frequency of dynamic screenshot is greater or equal to the frame rate of the video displayed on the screen during normal operation of the mobile terminal.
